(19) United States
(12) Patent Application Publication
(10) Pub. No.: US 2020/0233365 A1
(43) Pub. Date: Jul. 23, 2020

(54) CLEANING DEVICE, PROCESS CARTRIDGE, AND IMAGE FORMING APPARATUS

(71) Applicants: Hideki Kimura, Kanagawa (JP); Akira Fujimori, Kanagawa (JP); Hiroshi Kikuchi, Kanagawa (JP); Yutaka Takahashi, Kanagawa (JP); Hiroyuki Uenishi, Kanagawa (JP); Yusuke Ishizuka, Kanagawa (JP); Johji Yahagi, Kanagawa (JP)

(72) Inventors: Hideki Kimura, Kanagawa (JP); Akira Fujimori, Kanagawa (JP); Hiroshi Kikuchi, Kanagawa (JP); Yutaka Takahashi, Kanagawa (JP); Hiroyuki Uenishi, Kanagawa (JP); Yusuke Ishizuka, Kanagawa (JP); Johji Yahagi, Kanagawa (JP)

(73) Assignee: Ricoh Company, Ltd., Tokyo (JP)

(21) Appl. No.: 16/735,296

(22) Filed: Jan. 6, 2020

(30) Foreign Application Priority Data
Jan. 21, 2019 (JP) 2019-007772

(51) Int. Cl. G03G 21/00

(52) U.S. Cl. CPC G03G 21/0035

(57) ABSTRACT

A cleaning device includes a brush roller configured to contact an image bearer while rotating to remove toner adhering to an image bearer, a bias applying device configured to apply a bias to the brush roller, and control circuitry configured to causes the bias applying device to apply a first bias in a first period from when the brush roller is new to when a cumulative travel distance or a cumulative rotation time of the brush roller reaches a predetermined value, and to apply a second bias in a second period after the first period. The first bias sends a first current through the brush roller, and the second bias sends a second current through the brush roller. The absolute value of the first current is smaller than the absolute value of the second current.

### CROSS-REFERENCE TO RELATED APPLICATION

This patent application is based on and claims priority pursuant to 35 U.S.C. § 119(a) to Japanese Patent Application No. 2019-007772, filed on Jan. 21, 2019, in the Japan Patent Office, the entire disclosure of which is hereby incorporated by reference herein.

### BACKGROUND

### Technical Field

Embodiments of the present disclosure generally relate to a cleaning device to remove toner adhering to a surface of an image bearer, such as a photoconductor drum, a photoconductor belt, an intermediate transfer belt, an intermediate transfer drum, or the like; a process cartridge incorporating the cleaning device; and an electrophotographic image forming apparatus, such as a copier, a printer, a facsimile machine, or a multifunction peripheral (MFP) having at least two of such capabilities, incorporating the process cartridge.

### Description of the Related Art

Some image forming apparatuses, such as copiers and printers, include an image bearer, such as a photoconductor drum, a photoconductor belt, an intermediate transfer belt, an intermediate transfer drum, or the like, and a brush roller that contacts a surface of the image bearer to remove untransferred toner remaining on the image bearer.

### SUMMARY

Embodiments of the present disclosure describe an improved cleaning device that includes a brush roller configured to contact an image bearer while rotating in a predetermined direction to remove toner adhering to a surface of the image bearer, a bias applying device configured to apply a bias to the brush roller, and control circuitry configured to cause the bias applying device to apply a first bias to the brush roller in a first period from when the brush roller is new to when a cumulative travel distance or a cumulative rotation time of the brush roller reaches a predetermined value, and configured to apply a second bias to the brush roller in a second period after the first period. The first bias sends a first current through the brush roller, and the second bias sends a second current through the brush roller. The absolute value of the first current is smaller than the absolute value of the second current.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a configuration of an image forming apparatus according to an embodiment of the present disclosure;

FIG. 2 is a schematic view of a process cartridge of the image forming apparatus illustrated in FIG. 1 and the surrounding structure;

FIG. 3 is an enlarged view of a part of a cleaning device disposed within the process cartridge in FIG. 2;

FIG. 4 is a flowchart depicting a control process that controls a bias applied to a brush roller of the cleaning device in FIG. 3;

FIGS. 5A and 5B are tables of results of experiments;

FIG. 6 is an enlarged view illustrating a part of the cleaning device according to one variation of the present disclosure; and

FIGS. 7A and 7B are enlarged views illustrating a part of the cleaning device according to other variations of the present disclosure.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

Embodiments of the present disclosure are described in detail with reference to drawings. It is to be understood that identical or similar reference numerals are assigned to identical or corresponding components throughout the drawings, and redundant descriptions are omitted or simplified below as required.

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

It is to be noted that the suffixes Y, M, C, and K attached to each reference numeral indicate only that components indicated thereby are used for forming yellow, magenta, cyan, and black images, respectively, and hereinafter may be omitted when color discrimination is not necessary.

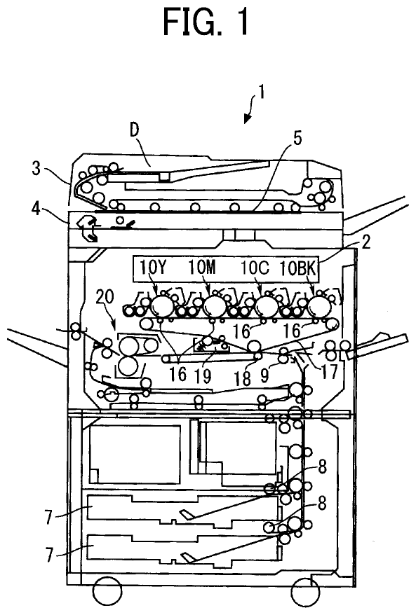

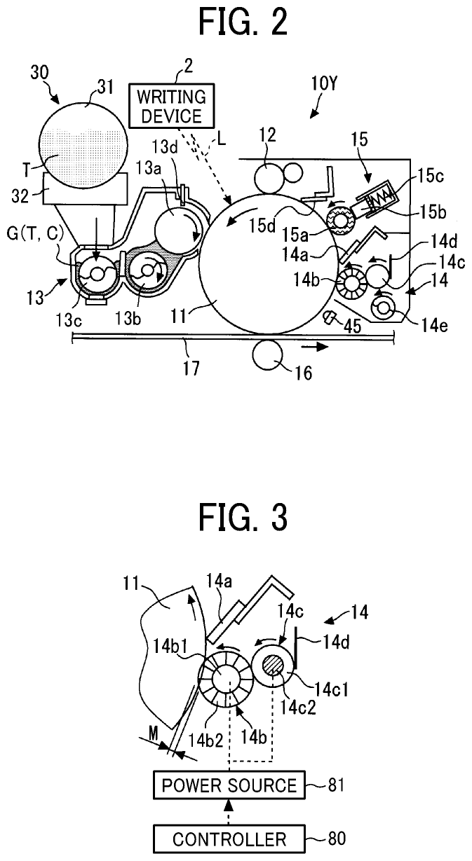

With reference to FIGS. 1 and 2, configuration and operation of an image forming apparatus 1 are described below.

FIG. 1 is a schematic view illustrating a configuration of the image forming apparatus 1 according to the present embodiment. FIG. 2 is a cross-sectional view illustrating a configuration of a process cartridge (image forming unit) 10Y for yellow installed in the image forming apparatus 1 illustrated in FIG. 1.

It is to be noted that the four process cartridges 10Y, 10M, 10C, and 10BK have a similar configuration except for the color of toner used in image forming processes, and thus the process cartridge 10Y is illustrated as a representative in FIG. 2.

In FIG. 1, the image forming apparatus 1, which is a tandem-type color copier in the present embodiment, includes a writing device 2, a document conveyance device 3, and a scanner (document reading device) 4. The scanner 4 scans image data for the documents D. The document conveyance device 3 transports documents D to the scanner 4. The writing device 2 emits a laser beam based on input image data from the scanner 4.

The image forming apparatus 1 further includes a sheet feeder 7 (in this case, a plurality of sheet feeders 7), a registration roller pair 9, and the four process cartridges (image forming units) 10Y, 10M, 10C, and 10BK. The sheet feeder 7 accommodates a stack of sheets such as paper sheets. The registration roller pair 9 adjusts timing of conveyance of the sheet. The process cartridges 10Y, 10M, 10C, and 10BK form toner images of yellow, magenta, cyan, and black, respectively, on the sheet.

The image forming apparatus 1 further includes primary transfer rollers 16 and an intermediate transfer belt 17. The toner images formed on photoconductor drums 11 (see FIG. 2) of the respective process cartridges 10Y, 10M, 10C, and 10BK are transferred to and superimposed on the intermediate transfer belt 17 by the primary transfer rollers 16, thereby forming a multicolor toner image.

The image forming apparatus 1 further includes a secondary transfer roller 18, a belt cleaning device 19, and a fixing device 20. The secondary transfer roller 18 transfers the multicolor toner image on the intermediate transfer belt 17 onto the sheet. The belt cleaning device 19 cleans the intermediate transfer belt 17. The fixing device 20 fixes the multicolor toner image (unfixed image) on the sheet.

A description is provided below of the operation of the image forming apparatus 1 when forming a normal color image.

The document conveyance device 3 transports, with conveyance rollers, the document D from a document table onto a platen (exposure glass) 5 of the scanner 4. Thus, the document D is loaded on the platen 5. Then, the scanner 4 optically scans the image data for the document D set on the platen 5.

The yellow, magenta, cyan, and black image data are transmitted to the writing device 2. The writing device 2 irradiates the photoconductor drums (image bearers) 11 of the corresponding process cartridges 10Y, 10M, 10C, and 10BK with laser beams (exposure light) L based on the yellow, magenta, cyan, and black image data, respectively.

Meanwhile, the photoconductor drum 11 (see FIG. 2) in each of the four process cartridges 10Y, 10M, 10C, and 10BK rotates in a predetermined direction (i.e., counterclockwise in FIG. 2). A charging device 12 uniformly charges a surface of the photoconductor drum 11 at a position facing each other (charging process). Thus, the surface of the photoconductor drum 11 is charged to a certain potential. Subsequently, the surface of the photoconductor drum 11 thus charged reaches a position where the surface of the photoconductor drum 11 is scanned by the laser beam L.

The writing device 2 emits the laser beam L from each of four light sources according to the image data. The respective laser beams L pass through different optical paths for components of yellow, magenta, cyan, and black (exposure process).

The laser beam L for the yellow component is directed to the surface of the photoconductor drum 11 as the image bearer that is the first from the left among the photoconductor drums 11 (see FIG. 2) of the four process cartridges 10Y, 10M, 10C, and 10BK in FIG. 1. At that time, a polygon mirror rotates at high speed to deflect the laser beam L for the yellow component in an axial direction of rotation of the photoconductor drum 11 (i.e., the main scanning direction) so that the laser beam L scans the photoconductor drum 11. Thus, an electrostatic latent image for yellow is formed on the surface of the photoconductor drum 11 charged by the charging device 12.

Similarly, the laser beam L for the magenta component is directed to the surface of the photoconductor drum 11 of the process cartridge 10M that is the second from the left in FIG. 1, thus forming an electrostatic latent image for magenta thereon. The laser beam L for the cyan component is directed to the surface of the photoconductor drum 11 of the process cartridge 10C that is the third from the left in FIG. 1, thus forming an electrostatic latent image for cyan thereon. The laser beam L for the black component is directed to the surface of the photoconductor drum 11 of the process cartridge 10BK that is the fourth from the left in FIG. 1, thus forming an electrostatic latent image for black thereon.

Then, the surface of the photoconductor drum 11 having the electrostatic latent image reaches a position opposite the developing device 13. The developing device 13 deposits toner of each color onto the surface of the photoconductor drum 11 and develops the electrostatic latent image on the photoconductor drum 11 into a visible toner image (development process).

Subsequently, after the development process, the surface of the photoconductor drum 11 reaches a position facing the intermediate transfer belt 17 (i.e., a primary transfer nip). The primary transfer rollers 16 are disposed at positions where the photoconductor drums 11 face the intermediate transfer belt 17 and in contact with an inner surface of the intermediate transfer belt 17, respectively. At the positions of the primary transfer rollers 16, the toner images on the photoconductor drums 11 of respective colors are transferred and superimposed onto the intermediate transfer belt 17, forming the multicolor toner image thereon (primary transfer process).

After the primary transfer process, the surface of the photoconductor drum 11 passes through a discharge lamp 45 and reaches a position opposite a cleaning device 14. At this position, a cleaning blade 14a and a brush roller 14b remove substances on the photoconductor drum 11, such as toner (i.e., untransferred toner) adhering to the surface of the photoconductor drum 11, and the removed toner is collected in the cleaning device 14 (cleaning process). A conveying screw 14e discharges (transports) the untransferred toner collected in the cleaning device 14 outside the cleaning device 14, and the untransferred toner is collected, as excess toner, in an excess toner receptacle.

Then, the surface of the photoconductor drum 11 passes through a lubricant supply device 15 and a discharge device to complete a series of image forming processes performed on the photoconductor drum 11.

As described above, the multicolor toner image is formed on the intermediate transfer belt 17 by transferring and superimposing the respective single-color toner images on the photoconductor drums 11. Then, the intermediate transfer belt 17 carrying the multicolor toner image moves clockwise in FIG. 1 to reach a position opposite the secondary transfer roller 18. The secondary transfer roller 18 transfers the multicolor toner image carried on the intermediate transfer belt 17 onto the sheet (secondary transfer process).

After the secondary transfer process, the surface of the intermediate transfer belt 17 reaches a position opposite the belt cleaning device 19. The belt cleaning device 19 collects untransferred toner adhering to the intermediate transfer belt 17 to complete a sequence of transfer processes performed on the intermediate transfer belt 17.

The sheet is transported from the sheet feeder 7 via the registration roller pair 9 to a secondary transfer nip between the intermediate transfer belt 17 and the secondary transfer roller 18.

More specifically, a sheet feeding roller 8 feeds the sheet from the sheet feeder 7 that contains multiple sheets such as paper sheets, and the sheet is then guided by a sheet guide to the registration roller pair (timing roller pair) 9. The sheet that has reached the registration roller pair 9 is transported toward the secondary transfer nip, timed to coincide with the arrival of the multicolor toner image on the intermediate transfer belt 17.

Subsequently, the sheet carrying the multicolor image is guided to the fixing device 20 by a conveyance belt. The fixing device 20 includes a fixing belt and a pressure roller pressing against each other. In a nip therebetween, the multicolor image (toner image) is fixed on the sheet.

After the fixing process, output rollers eject the sheet as an output image outside the image forming apparatus 1 to complete a sequence of image forming processes.

With reference to FIG. 2, the process cartridge 10Y is described in further detail below.

As illustrated in FIG. 2, the photoconductor drum 11 as the image bearer, the charging device (charging roller) 12, the developing device 13, the cleaning device 14, and the lubricant supply device 15 are integral parts of the process cartridge 10Y.

The photoconductor drum 11 as the image bearer used in the present embodiment is an organic photoconductor to be charged to a negative polarity and includes a photosensitive layer formed on a drum-shaped conductive support.

For example, the photoconductor drum 11 has a multilayered construction and includes a base coat serving as an insulation layer, the photosensitive layer, and a surface layer (i.e., a protection layer) sequentially coating the conductive support as a substrate. The photosensitive layer includes a charge generation layer and a charge transport layer.

The photoconductor drum 11 is rotated counterclockwise in FIG. 2 by a drive motor.

With reference to FIG. 2, the charging device 12 is a charging roller including a conductive core and an elastic layer of moderate resistivity coating the conductive core. Receiving a predetermined voltage, which includes a direct-current (DC) voltage and an alternating-current (AC) voltage superimposed on the DC voltage, from a power supply for charging, the charging device 12 uniformly charges the surface of the photoconductor drum 11 opposite the charging device 12.

The developing device 13 includes a developing roller 13a disposed opposite the photoconductor drum 11, a first conveying screw 13b disposed opposite the developing roller 13a, a second conveying screw 13c disposed opposite the first conveying screw 13b via a partition, and a doctor blade 13d disposed opposite the developing roller 13a. The developing roller 13a includes multiple magnets and a sleeve that rotates around the magnets. The magnets are stationary and generate magnetic poles around the circumference of the developing roller 13a. The magnets generate a plurality of magnetic poles on the developing roller 13a (sleeve) to bear a developer G on the developing roller 13a.

The developing device 13 contains a two-component developer G including toner T and carrier C.

The cleaning device 14 includes a cleaning blade 14a disposed in contact with the photoconductor drum 11 to clean the surface of the photoconductor drum 11, a brush roller 14b that slidingly contacts the photoconductor drum 11 to clean the surface of the photoconductor drum 11, a collection roller 14c to collect toner adhering to the surface of the brush roller 14b, a collection blade 14d to clean the surface of the collection roller 14c, and the conveying screw (conveyor) 14e to transport untransferred toner collected in the cleaning device 14 in a width direction, which is perpendicular to the surface of the paper on which FIG. 2 is drawn.

For example, the cleaning blade 14a is made of rubber, such as urethane rubber, and contacts the surface of the photoconductor drum 11, at a predetermined angle and with a predetermined pressure. With this configuration, substances such as toner adhering to the photoconductor drum 11 are mechanically scraped off and collected in the cleaning device 14 by the cleaning blade 14a. The substances adhering to the photoconductor drum 11 include paper dust from sheets of paper, discharge products appearing on the photoconductor drum 11 during electrical discharge by the charging device 12, and additives to toner. The cleaning blade 14a is disposed downstream from the brush roller 14b to be described later in the direction of rotation of the photoconductor drum 11.

The cleaning blade 14a contacts the photoconductor drum 11 against the direction of rotation of the photoconductor drum 11.

With reference to FIG. 3, it can be seen that the brush roller 14b is disposed upstream from the cleaning blade 14a in the direction of rotation of the photoconductor drum 11. The brush roller 14b contacts the photoconductor drum 11 while rotating in a predetermined direction (counterclockwise in FIG. 3). The brush roller 14b includes a shaft (core) 14b1 and a base fabric. Straight or looped bristles 14b2 are planted on the base fabric. The base fabric is wound around the outer periphery of the shaft (core) 14b1. As the bristles 14b2, resin fibers such as polyester, nylon, rayon, acrylic, vinylon, and vinyl chloride can be used. In the present embodiment, conductive fibers including conductivity-imparting agent such as carbon are used. For example, the bristles 14b2 have a bristle length of about 0.2 mm to 20 mm and a bristle density of about 20000 filaments per square inch (F/in²) to 100000 F/in². In particular, in the present embodiment, the bristles 14b2 having a bristle thickness of 6 denier or more are used.

The brush roller 14b receives driving force from the drive motor to rotate the photoconductor drum 11 via a gear train and rotates counterclockwise in FIGS. 2 and 3 in conjunction with the rotation of the photoconductor drum 11. The brush roller 14b is disposed with the bristles 14b2 pushed within a range of 0.5 to 1.5 mm with respect to the photoconductor drum 11 and slidingly contacts the photoconductor drum 11 against the direction of rotation of the photoconductor drum 11.

With this configuration, substances such as toner adhering to the photoconductor drum 11 are mechanically scraped off and collected in the cleaning device 14 by the brush roller 14b. The substances adhering to the photoconductor drum 11 include paper dust from sheets of paper, discharge products appearing on the photoconductor drum 11 during electrical discharge by the charging device 12, additives to toner, and carrier C in the two-component developer G contained in the developing device 13.

In particular, in the present embodiment, a bias (voltage) is applied to the brush roller 14b, and an electric field is formed between the photoconductor drum 11 and the brush roller 14b to electrostatically remove toner on the photoconductor drum 11 by the brush roller 14b.

A detail description of applying the bias to the brush roller 14b is deferred.

As described above, in addition to the cleaning blade 14a, the brush roller 14b is used to remove untransferred toner adhering to the photoconductor drum 11, thereby improving the cleaning performance of the cleaning device 14.

The collection roller 14c includes a shaft 14c2 and a roller portion 14c1 made of metal on the shaft 14c2 and is disposed so as to slidingly contact the bristles 14b2 of the brush roller 14b. The collection roller 14c rotates counterclockwise in FIG. 3 and contact the brush roller 14b against the direction of rotation of the brush roller 14b.

The collection blade 14d is a plate made of metal such as stainless steel and contacts the surface of the collection roller 14c at a predetermined angle and with a predetermined pressure.

After the collection roller 14c removes substances from the brush roller 14b, the collection blade 14d scrape off the substances on the collection roller 14c and collects the substances in the cleaning device 14. The substances include toner (untransferred toner on the photoconductor drum 11) removed by the brush roller 14b.

The conveying screw 14e includes a shaft and a screw blade wound around the shaft and rotates in a predetermined direction to transport substances such as toner collected in the cleaning device 14 to the excess toner receptacle. The conveying screw 14e receives driving force from the drive motor to rotate the photoconductor drum 11 via a gear train and rotates counterclockwise in FIG. 2 in conjunction with the rotation of the photoconductor drum 11.

With reference to FIG. 2, it can be seen that the lubricant supply device 15 includes a solid lubricant 15b, a lubricant supply roller 15a that slidingly contacts the solid lubricant 15b and supplies lubricant to the photoconductor drum 11, a compression spring 15c to bias the solid lubricant 15b to the lubricant supply roller 15a, and a leveling blade 15d that contacts the photoconductor drum 11 to level the lubricant supplied to the photoconductor drum 11 into a thin layer. The lubricant supply roller 15a includes an elastic foam layer that slidingly contacts the photoconductor drum 11.

The lubricant supply device 15 is disposed downstream from the cleaning device 14 (the cleaning blade 14a in particular) and upstream from the charging device 12 in the direction of rotation of the photoconductor drum 11. The leveling blade 15d is disposed downstream from the lubricant supply roller 15a in the direction of rotation of the photoconductor drum 11.

The lubricant supply roller 15a is a roller including a shaft (core) made of metal and the elastic foam layer made of, for example, polyurethane foam (urethane foam) coating the shaft. With the elastic foam layer kept contacting the surface of the photoconductor drum 11, the lubricant supply roller 15a rotates counterclockwise in FIG. 2. With this configuration, the lubricant is supplied from the solid lubricant 15b via the lubricant supply roller 15a to the photoconductor drum 11.

The lubricant supply roller 15a is driven to slidingly rotate against the direction of rotation of the photoconductor drum 11 that rotates counterclockwise in FIG. 2. That is, the lubricant supply roller 15a rotates counterclockwise in FIG. 2.

The lubricant supply roller 15a slidingly contacts both of the solid lubricant 15b and the photoconductor drum 11. While rotating, the lubricant supply roller 15a scrapes lubricant from the solid lubricant 15b and applies the lubricant to the photoconductor drum 11.

On the back side of the solid lubricant 15b opposite the lubricant supply roller 15a, the compression spring 15c is disposed to inhibit uneven contact between the lubricant supply roller 15a and the solid lubricant 15b. The compression spring 15c presses the solid lubricant 15b against the lubricant supply roller 15a.

The solid lubricant 15b is produced by mixing inorganic lubricant in fatty acid metal salts. The fatty acid metal salts preferably include zinc stearate. It is also preferable that the inorganic lubricant include at least one of talc, mica, and boron nitride.

The leveling blade 15d is a plate made of rubber, such as urethane rubber, and contacts the photoconductor drum 11 at a predetermined angle and with a predetermined pressure. The leveling blade 15d is disposed downstream from the lubricant supply roller 15a in the direction of rotation of the photoconductor drum 11. The leveling blade 15d levels off the lubricant on the photoconductor drum 11, which is supplied by the lubricant supply roller 15a, to a suitable amount uniformly on the photoconductor drum 11.

When the lubricant is applied from the solid lubricant 15b to the surface of the photoconductor drum 11 via the lubricant supply roller 15a, a powdery lubricant is applied to the surface of the photoconductor drum 11. In this state, lubricity is insufficient. Therefore, the leveling blade 15d functions as a component for thinning and leveling the lubricant. When the lubricant is leveled by the leveling blade 15d and becomes a coating on the photoconductor drum 11, the lubricant can fully exhibit lubricity.

In the present embodiment, the leveling blade 15d contacts the photoconductor drum 11 in the trailing direction with respect to the direction of rotation of the photoconductor drum 11.

Since the cleaning device 14 according to the present embodiment includes two separate blades (the cleaning blade 14a and the leveling blade 15d) for cleaning and lubrication, good cleaning performance and good lubrication performance are attained. Additionally, wear and deterioration of the cleaning blade 14a and the leveling blade 15d are alleviated by the lubricant on the photoconductor drum 11.

The image forming processes are described in further detail below with continued reference to FIG. 2.

The developing roller 13a rotates clockwise in FIG. 2. In the developing device 13, as the first and second conveying screws 13b and 13c, arranged via the partition, rotate as illustrated in FIG. 2, the developer G is circulated in the longitudinal direction of the developing device 13, being stirred with fresh toner T supplied from a toner supply device 30. The longitudinal direction of the developing device 13 is perpendicular to the surface of the paper on which FIG. 2 is drawn.

Thus, the toner T is triboelectrically charged and attracted to the carrier C. Then, the toner T is carried on the developing roller 13a together with the carrier C. The developer G carried on the developing roller 13a reaches the doctor blade 13d. The amount of the developer G on the developing roller 13a is regulated to a suitable amount by the doctor blade 13d, after which the developer G is carried to the development range opposite the photoconductor drum 11.

In the development range, the toner T in the developer G adheres to the electrostatic latent image on the photoconductor drum 11. Specifically, the toner T adheres to the electrostatic latent image by a development electric field formed by a potential difference (i.e., a developing potential) between a latent image potential (i.e., an exposure potential) of an image area irradiated with the laser beam L and a development bias applied to the developing roller 13a.

Subsequently, most of the toner T that adheres to the photoconductor drum 11 in the developing process is transferred to the intermediate transfer belt 17, and untransferred toner remaining on the surface of the photoconductor drum 11 is collected in the cleaning device 14 by the cleaning blade 14a and the brush roller 14b. Subsequently, the surface of the photoconductor drum 11 passes through the lubricant supply device 15 and the discharge device sequentially to complete a sequence of image forming processes.

In the present embodiment, the discharge lamp 45 is opposite the photoconductor drum 11 downstream from the primary transfer nip and upstream from the cleaning device 14. The discharge lamp 45 irradiates the photoconductor drum 11 with light for discharging upstream from the cleaning device 14, thereby reducing the electrostatic adhesion force of the toner to the photoconductor drum 11 and improving the cleaning performance of the cleaning device 14.

The toner supply device 30 of the image forming apparatus 1 includes a replaceable toner bottle 31 and a toner hopper 32. The toner hopper 32 holds and rotates the toner bottle 31 and supplies fresh toner T to the developing device 13. Each toner bottle 31 contains fresh toner T (yellow toner in FIG. 2). A helical projection is disposed on an inner surface of the toner bottle 31.

The fresh toner T in the toner bottle 31 is supplied through a toner supply inlet to the developing device 13 as the toner T existing in the developing device 13 is consumed. The consumption of the toner T in the developing device 13 is detected either directly or indirectly using a magnetic sensor disposed below the second conveying screw 13c of the developing device 13.

Next, the configuration and operation of the cleaning device 14 (the process cartridge 10) according to the present embodiment are described in further detail below.

As described above with reference to FIGS. 2 and 3, the cleaning device 14 according to the present embodiment includes the brush roller 14b that contacts the photoconductor drum (image bearer) 11 while rotating in a predetermined direction, thereby removing toner adhering to the surface of the photoconductor drum 11.

As illustrated in FIG. 3, a power source 81 applies a bias to the brush roller 14b. In the present embodiment, the power source (bias applying device) 81 applies a voltage having a polarity (positive polarity) opposite the polarity of toner (negative polarity in the present embodiment) to the brush roller 14b. Specifically, the power source 81 is electrically connected to the shaft 14b1 of the brush roller 14b, and circuitry serving as a controller 80 causes the power source 81 to change the magnitude of the bias applied to the brush roller 14b.

As described above, since the bias is applied to the brush roller 14b from the power source (bias applying device) 81, toner adhering to the photoconductor drum 11 is easily moved electrostatically toward the brush roller 14b. Therefore, the cleaning performance of the brush roller 14b is improved.

In the present embodiment, the power source 81 also applies a voltage having a polarity opposite to polarity of toner to the collection roller 14c. As a result, the toner carried on the brush roller 14b is easily moved electrostatically toward the collection roller 14c, and the cleaning performance by the collection roller 14c is improved. In the present embodiment, the power source (bias applying device) 81 applies a first bias to the brush roller 14b in a first period from when the brush roller 14b is new to when a cumulative travel distance (or a cumulative rotation time) of the brush roller 14b reaches a predetermined value A and applies a second bias to the brush roller 14b in a second period after the cumulative travel distance (or the cumulative rotation time) of the brush roller 14b reaches the predetermined value A. The first bias sends a first current through the brush roller 14b, and the second bias sends a second current through the brush roller 14b. The controller 80 controls the power source 81 so that the absolute value of the first current is smaller than the absolute value of the second current.

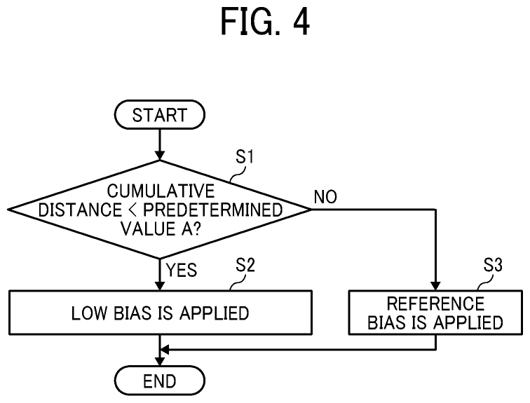

Specifically, as illustrated in FIG. 4, the controller 80 determines whether the cumulative travel distance (or the cumulative rotation time) of the brush roller 14b has reached the predetermined value A (step 51).

As a result, when the controller 80 determines that the cumulative travel distance has not reached the predetermined value A, the power source 81 applies a low bias smaller than a reference bias to the brush roller 14b, and a relatively small current flows through the brush roller 14b (step S2). On the other hand, when the controller 80 determines that the cumulative distance has reached the predetermined value A, the power source 81 applies the reference bias to the brush roller 14b, and a relatively large current flows to the brush roller 14b (step S3).

More specifically, in the present embodiment, the period from when the brush roller 14b is new to when the cumulative travel distance reaches the predetermined value A (the predetermined value A is set to 9000 m in the present embodiment) is defined as the first period, and the period after the cumulative travel distance reaches the predetermined value A to the end of the service life is defined as the second period. For example, the controller 80 adjusts the bias applied from the power source 81 to the brush roller 14b so that the current value of 1 μA flows through the brush roller 14b in the first period (i.e., the first current) and the current value of 2 μA flows through the brush roller 14b in the second period (i.e., the second current).

Here, the current value that flows through the brush roller 14b in the second period is equivalent to the current generally applied to the brush roller 14b and can be referred to as a reference value. Therefore, in the present embodiment, the current that is smaller than the reference value (half of the reference value) flows through the brush roller 14b in the first period.

A new brush roller 14b is a brush roller 14b not used yet in any device. The new state of the brush roller 14b can be detected by reading data stored in a radiofrequency identification (RFID) tag installed in the cleaning device 14 (process cartridge 10Y). The RFID tag is a chip in which the data on usage history is written), and the data is read by a reader of the image forming apparatus 1.

The cumulative travel distance is the cumulative distance (linear speed x rotation time) in which the brush roller 14b has been operated since the start of use. The cumulative travel distance can be obtained based on the cumulative rotation time of the drive motor that drives the cleaning device 14 (and the photoconductor drum 11). The cumulative travel distance is updated in a memory of the controller 80 any time the cleaning device 14 is operated.

Thus, in the present embodiment, in the first period, which is an initial stage of the brush roller 14b, the bias is applied to the brush roller 14b so that the current value smaller than the reference value flows through the brush roller 14b. Therefore, the photoconductor drum 11 is prevented from being damaged.

Specifically, when the brush roller 14b is new, the electrical resistance of the bristles 14b2 may not be stabilized, and the electrical resistance of the portion of the bristles 14b2 that contacts the photoconductor drum 11 may be locally reduced. In such a case, a large current may locally flow from the brush roller 14b to the photoconductor drum 11, thereby damaging and deteriorating the photoconductor drum 11. Then, when the photoconductor drum 11 is damaged in such a manner, an abnormal image, such as an image with black streaks, is produced. Such a phenomenon is less likely to occur after the brush roller 14b has been used to some extent, and the electrical resistance of the bristles 14b2 becomes stable.

Accordingly, in the present embodiment, while the electrical resistance of the bristles 14b2 of the brush roller 14b is not stable (the first period), the controller 80 controls the power source 81 so that a large current does not flow through the brush roller 14b, thereby reducing the occurrence of such a problem.

As the brush roller 14b approaches the end of the service life, the bristles 14b2 fatigues and mechanical cleaning performance decreases. However, the brush roller 14b secures the mechanical cleaning performance at the initial stage of the brush roller 14b (the first period). Therefore, even if the low bias described above is applied to the brush roller 14b, adequate cleaning performance can be reliably achieved. On the other hand, after the brush roller 14b has shifted to the second period, the mechanical cleaning performance is gradually not secured. Therefore, as described above, the reference bias is applied to the brush roller 14b, thereby reliably achieving adequate cleaning performance.

As a result, in the present embodiment, the photoconductor drum 11 can be prevented from being damaged while securing adequate cleaning performance by the brush roller 14b from the start of use to the end of the service life.

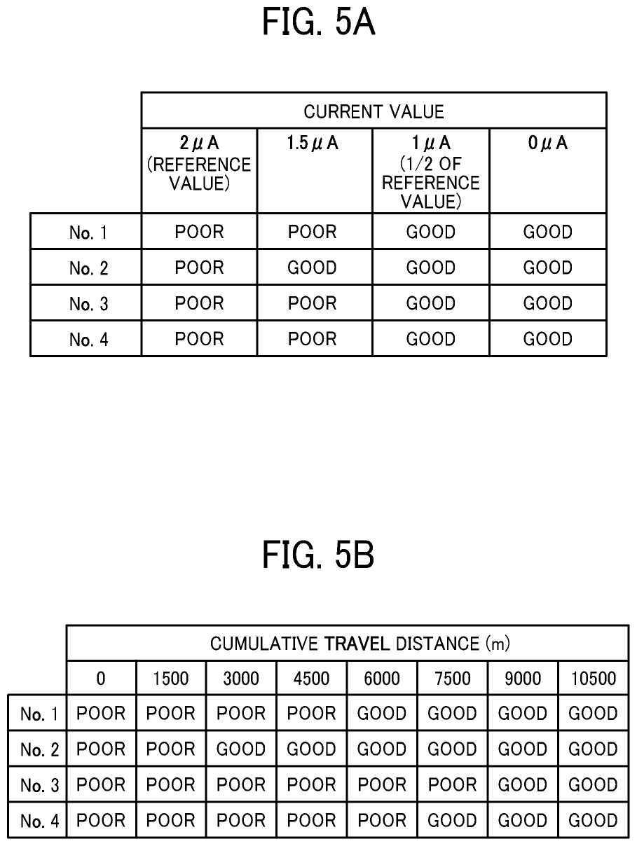

In the present embodiment, the current value (first current) X1 that flows through the brush roller 14b in the first period is preferably is not greater than half of the current value (second current) X2 that flows through the brush roller 14b in the second period (X1≤X2×½) based on results of experiments illustrated in FIG. 5A.

FIG. 5A is a table illustrating the results of experiments in which the occurrence of black streaks in the formed image was confirmed by using four devices No. 1 to No. 4 with the brush roller 14b in the new state. The bias (current value) applied to the brush roller 14b is adjusted to four different levels. In FIG. 5A (and FIG. 5B to be described later), the rating “good” represents that black streaks and cleaning failure did not occur, and the rating “poor” represents that black streaks did occur.

According to the results of experiments illustrated in FIG. 5A, black streaks are less likely to occur by setting the current value X1 that flows through the brush roller 14b in the first period to half or less of the reference value (current value) X2.

In the present embodiment, the current value X1 flowing through the brush roller 14b in the first period is half of the reference value X2. However, the current value X1 flowing through the brush roller 14b in the first period is preferably half of the reference value X2 or less, and can be 0 based on the results of experiments illustrated in FIG. 5A.

In the present embodiment, after the cumulative travel distance of the brush roller 14b reaches 9000 m, the bias applied to the brush roller 14b is increased from the low bias to the reference bias based on results of experiments illustrated in FIG. 5B.

FIG. 5B is a table illustrating the results of experiments in which a relation between the occurrence of black streaks and the cumulative travel distance was confirmed by using four devices No. 1 to No. 4 with the brush roller 14b in the new state. The bias applied to the brush roller 14b was fixed at the reference bias, that is, the current value was 2 μA.

According to the results of experiments illustrated in FIG. 5B, if the cumulative travel distance exceeds 9000 m, black streaks are less likely to occur even if the current value that flows through the brush roller 14b is large.

With reference to FIG. 3, in the present embodiment, the brush roller 14b is disposed with the bristles 14b2 pushed within a range of 0.5 to 1.5 mm with respect to the photoconductor drum 11. In other words, a pushing amount M of the bristles 14b2 with respect to the photoconductor drum (image bearer) 11 is set within the range of 0.5 to 1.5 mm. Note that the pushing amount M of the bristles 14b2 of the brush roller 14b with respect to the photoconductor drum 11 is a length of the bristles 14b2 that overlap the photoconductor drum 11 as illustrated in FIG. 3 when it is assumed that there is no photoconductor drum 11.

When the pushing amount M of the bristles 14b2 is larger than 1.5 mm, black streaks are likely to occur, and when the pushing amount M of the bristles 14b2 is smaller than 0.5 mm, adequate cleaning performance is less likely to be secured.

For this reason, the pushing amount M of the bristles 14b2 is set within the range of 0.5 to 1.5 mm.

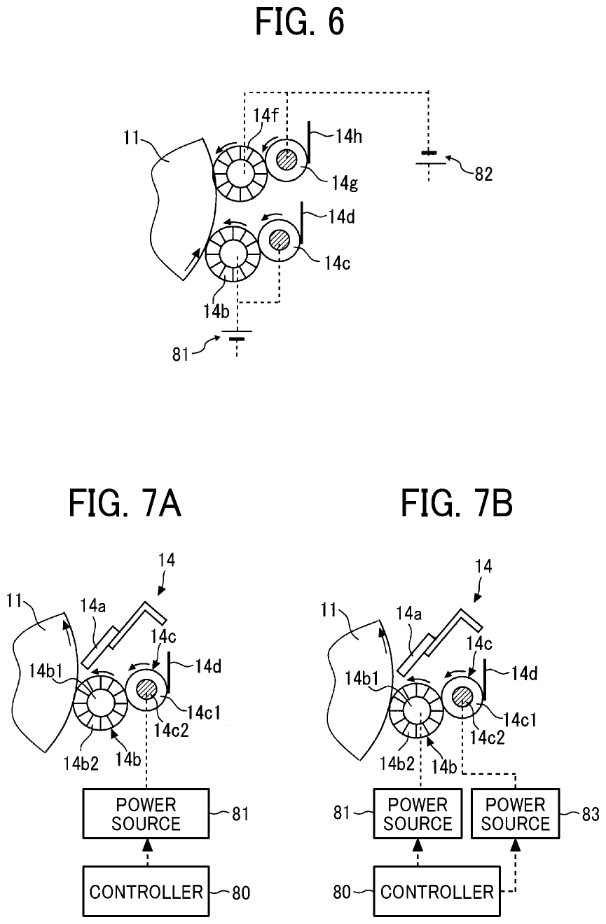

FIG. 6 is an enlarged view illustrating a part of the cleaning device 14 according to a variation of the present disclosure.

As illustrated in FIG. 6, the cleaning device 14 according to the variation includes first and second brush rollers 14b and 14f, collection rollers 14c and 14g, and collection blades 14d and 14h. A bias having positive polarity is applied to the first brush roller 14b disposed upstream and the collection roller 14c from the first power source (bias applying device) 81, and a bias having negative polarity is applied to the second brush roller 14f disposed downstream and the collection roller 14h from a second power source (bias applying device) 82. As described above, since the second brush roller 14f to which the bias having the same polarity as the polarity of toner is provided, the reversely charged toner adhering to the photoconductor drum 11 is electrostatically removed by the second brush roller 14f. This configuration is useful because the untransferred toner on the photoconductor drum 11 may be reversely charged under the influence of the electric field having the same polarity as the polarity of toner at the primary transfer nip.

When the two brush rollers 14b and 14f are provided, similarly to the above-described embodiment, the bias is applied to the first brush roller 14b in the first period which is an initial stage of the brush roller 14b so that the current value smaller than the reference value flows through the second brush roller 14f in addition to the first brush roller 14b. Specifically, in the variation, the controller 80 controls the second power source 82 to cause a current value of −X1 to flow through the second brush roller 14f in the first period and to cause a current value of −X2 to flow through the second brush roller 14f in the second period. Here, the absolute value of −X1 is smaller than the absolute value of −X2 (i.e., |−X1|≤|−X2|).

In the variation, similarly to the above-described embodiments, the photoconductor drum 11 is prevented from being damaged.

FIGS. 7A and 7B are enlarged views of a part of the cleaning device 14 according to other variations and correspond to FIG. 3 according to the above-described embodiment.

As illustrated in FIG. 7A, the power source 81 to apply a bias to the brush roller 14b may indirectly apply a bias to the brush roller 14b. Specifically, in the example in FIG. 7A, the power source 81 is connected to the shaft 14c2 of the collection roller 14c, and a bias is directly applied from the power source 81 to the collection roller 14c. Accordingly, the bias is applied to the brush roller 14b via the collection roller 14c.

Alternatively, as illustrated in FIG. 7B, another power source 83 to directly apply a bias to the collection roller 14c may be provided in addition to the power source 81 to directly apply a bias to the brush roller 14b. Such a configuration is useful when the magnitude and application timing of the bias applied to the brush roller 14b and the bias applied to the collection roller 14c are different.

In other variations, similarly to the above-described embodiments, the photoconductor drum 11 is prevented from being damaged.

As described above, in the cleaning device 14 according to the above-described embodiment, a bias applying device such as power source 81 applies a first bias to a brush roller such as the brush roller 14b in a first period from when the brush roller 14b is new to when a cumulative travel distance (or a cumulative rotation time) of the brush roller 14b reaches the predetermined value A. A first current flows through the brush roller 14b when the first bias applied. Further, the power source (bias applying device) 81 applies a second bias to the brush roller 14b in a second period after the cumulative travel distance (or the cumulative rotation time) reaches the predetermined value A. A second current flows through the brush roller 14b when the second bias is applied. The absolute value of the first current is smaller than the absolute value of the second current.

With this configuration, the photoconductor drum 11 is prevented from being damaged by applying the bias to the brush roller 14b.

Therefore, according to the present disclosure, a cleaning device, a process cartridge, and an image forming apparatus can be provided that prevent an image bearer from being damaged due to a bias applied to a brush roller.

In the above-described embodiments, the respective components (i.e., the photoconductor drum 11, the charging device 12, the developing device 13, the cleaning device 14, and the lubricant supply device 15) of the image forming unit are combined together as the process cartridge 10 to make the image forming unit compact and to facilitate maintenance work. Alternatively, the cleaning device 14 may not be included in the process cartridge and can be independently installed in the image forming apparatus 1. In such a configuration, similar effects to those of the above-described embodiments are also attained.

It is to be noted that the term “process cartridge” used in the present disclosure means a removable unit including an image bearer and at least one of a charging device to charge the image bearer, a developing device to develop latent images on the image bearer, and a cleaning device to clean the image bearer that are united together, and is designed to be removably installed as a united part in the image forming apparatus.

In the above-described embodiment, the present disclosure is applied to the cleaning device 14 to remove untransferred toner, which is substances to be removed, on the photoconductor drum 11 as the image bearer. On the other hand, the present disclosure can be readily applied to a cleaning device to remove untransferred toner on a photoconductor belt serving as the image bearer, a cleaning device such as the belt cleaning device 19 in the above-described embodiment to remove untransferred toner on an intermediate transfer belt such as the intermediate transfer belt 17 serving as the image bearer (and an intermediate transferor), and a cleaning device to remove untransferred toner on an intermediate transfer drum serving as the image bearer (and the intermediate transferor).

In the above-described embodiments, the present disclosure is applied to the cleaning device 14 included in the image forming apparatus 1 that performs multicolor image formation. Alternatively, the present disclosure can also be applied readily to a cleaning device included in a monochrome image forming apparatus.

In the above-described embodiments, the present disclosure is applied to the cleaning device 14 provided with the cleaning blade 14a. Alternatively, the present disclosure can also be applied readily to a cleaning device without a cleaning blade.

In such configurations, effects similar to those described above are also attained.

The above-described embodiments are illustrative and do not limit the present disclosure. Thus, numerous additional modifications and variations are possible in light of the above teachings. It is therefore to be understood that within the scope of the present disclosure, the present disclosure may be practiced otherwise than as specifically described herein. The number, position, and shape of the components described above are not limited to those embodiments described above. Desirable number, position, and shape can be determined to perform the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. A cleaning device comprising:
a brush roller configured to contact an image bearer while rotating in a predetermined direction to remove toner adhering to a surface of the image bearer;
a bias applying device configured to apply a bias to the brush roller; and
control circuitry configured to cause the bias applying device to:
apply a first bias to the brush roller in a first period starting from when the brush roller is new to when a cumulative travel distance or a cumulative rotation time of the brush roller reaches a predetermined value, the first bias causing a first current to flow through the brush roller; and
apply a second bias to the brush roller in a second period after the first period, the second bias causing a second current to flow through the brush roller, an absolute value of the first current being smaller than the absolute value of the second current.

2. The cleaning device according to claim 1,
wherein the absolute value of the first current that flows through the brush roller in the first period is not greater than half the absolute value of the second current that flows through the brush roller in the second period.

3. The cleaning device according to claim 1,
wherein the absolute value of the first current that flows through the brush roller in the first period is 0.

4. The cleaning device according to claim 1,
wherein the brush roller includes:
a shaft;
a base fabric wound around the shaft; and
bristles, straight or looped, planted on the base fabric, and
wherein a pushing amount of the bristles with respect to the image bearer is within a range of 0.5 to 1.5 mm.

5. The cleaning device according to claim 1, further comprising a cleaning blade configured to contact the image bearer at a position downstream from the brush roller in a direction of rotation of the image bearer to remove toner adhering to the surface of the image bearer.

6. A process cartridge comprising:
the image bearer; and
the cleaning device according to claim 1, configured to clean the surface of the image bearer,
wherein the process cartridge is removably installable in an image forming apparatus, and
wherein the image bearer and the cleaning device are integral parts of the process cartridge.

7. An image forming apparatus comprising the cleaning device according to claim 1.
